(19) United States
(12) Patent Application Publication
(10) Pub. No.: US 2022/0083766 A1
(43) Pub. Date: Mar. 17, 2022

(54) COMPUTER PROGRAM, SERVER, TERMINAL DEVICE, SYSTEM, AND METHOD

(71) Applicant: GREE, Inc., Tokyo (JP)

(72) Inventor: Masashi WATANABE, Tokyo (JP)

(73) Assignee: GREE, Inc., Tokyo (JP)

(21) Appl. No.: 17/531,805

(22) Filed: Nov. 22, 2021

Related U.S. Application Data
(63) Continuation of application No. PCT/JP2020/018556, filed on May 7, 2020.

(30) Foreign Application Priority Data
May 20, 2019 (JP) 2019-094557

(51) Int. Cl. G06K 9/00; G06T 13/40; G06T 13/80; H04M 1/72427

(52) U.S. Cl. CPC G06K 9/00315; G06K 9/00281; G06T 2200/24; G06T 13/80; H04M 1/72427; G06T 13/40

(57) ABSTRACT

A device in accordance with the present application includes a processor configured to a processor configured to obtain, based on data of a performer obtained by a sensor, an amount of change of each of a plurality of specific parts of a face of the performer; obtain, for at least one specific feeling of a plurality of specific feelings associated with each of the specific parts, a first score based on the amount of change of the specific part; obtain a second score, based on a sum of the first scores obtained for the at least one specific feeling, for each specific feeling of the plurality of specific feelings; and select a specific feeling, having a second score exceeding a threshold from among the plurality of specific feelings, as a feeling expressed by the performer.

### CROSS-REFERENCE TO RELATED APPLICATIONS

The present application claims the benefit of priority to Japanese Patent Application No. 2019-094557, filed May 20, 2019, the content of which is incorporated by reference in its entirety.

### TECHNICAL FIELD

The present application relates to a computer program, a server, a terminal device, a system, and a method for controlling the facial expression of a virtual character displayed in a moving image, a game, or the like on the basis of the facial expression of the performer (user).

### BACKGROUND

A conventional example of a service that uses a technique for controlling the facial expression of a virtual character displayed in an application on the basis of the facial expression of the performer is referred to as “Animoji” (“Using Animoji in “iPhone X or later”, [online], Oct. 24, 2018, Apple Japan Inc., searched on Mar. 12, 2019, [URL: https://supportapple.com/ja-jp/HT208190]) (Non-Patent Literature 1). This service allows the user to vary the facial expression of an avatar displayed in a messenger application by varying the user's facial expression while seeing a smartphone equipped with a camera that detects the deformation of the shape of the face.

Another conventional service is referred to as “custom cast” (“custom cast”, [online], Oct. 3, 2018, Dwango Co., Ltd., searched on Mar. 12, 2019, [URL: https://customcast.jp/]) (Non-Patent Literature 2). In this service, the user assigns one of multiple prepared facial expressions to one of a plurality of direction of flicks on the screen of a smartphone. In delivering a moving image, the user can also give an avatar displayed in the moving image a desired facial expression by flicking on the screen in a direction corresponding to the desired facial expression.

Non-Patent Literature 1 and Non-Patent Literature 2 are incorporated by reference in this specification in their entirety.

Applications for displaying a virtual character (an avatar or the like) are desired to give the character an impressive facial expression. The impressive facial expression includes the following three examples. A first example is a facial expression that expresses emotions including joy, anger, sorrow, and pleasure. A second example is a facial expression that is unrealistically deformed like comics. An example of this facial expression is a facial expression in which both eyes pop out from the face. A third example is a facial expression in which signs, figures and/or color are added. Examples of this facial expression include a facial expression with tears spilling, a facial expression with a bright red face, and an angry facial expression with triangular eyes. The impressive facial expression is not limited to the above examples.

### SUMMARY

In an exemplary implementation of the present application, a device comprises a processor configured to obtain, based on data of a performer obtained by a sensor, an amount of change of each of a plurality of specific parts of a face of the performer; obtain, for at least one specific feeling of a plurality of specific feelings associated with each of the specific parts, a first score based on the amount of change of the specific part; obtain a second score, based on a sum of the first scores obtained for the at least one specific feeling, for each specific feeling of the plurality of specific feelings; and select a specific feeling, having a second score exceeding a threshold from among the plurality of specific feelings, as a feeling expressed by the performer.

### BRIEF DESCRIPTION OF THE DRAWINGS

FIG. 1 is a block diagram illustrating an example of the configuration of a communication system according to an embodiment;

FIG. 2 is a block diagram illustrating, in outline, an example of the hardware configuration of the terminal device (the server) illustrated in FIG. 1;

FIG. 3 is a block diagram illustrating, in outline, an example of the functions of the terminal device (the server) illustrated in FIG. 1;

FIG. 4 is a flowchart illustrating an example of operations performed by the entire communication system illustrated in FIG. 1;

FIG. 5 is a flowchart illustrating a specific example of operations for generating and transmitting a moving image of the operations illustrated in FIG. 4;

FIG. 6 is a schematic diagram conceptually illustrating a specific example of the first scores obtained by the communication system illustrated in FIG. 1;

FIG. 7 is a schematic diagram conceptually illustrating another specific example of the first scores obtained by the communication system illustrated in FIG. 1;

FIG. 8 is a schematic diagram conceptually illustrating yet another specific example of the first scores obtained by the communication system illustrated in FIG. 1;

FIGS. 9A and 9B are schematic diagrams conceptually illustrating specific examples of second scores obtained by the communication system illustrated in FIG. 1; and

FIG. 10 is a block diagram of processing circuitry that performs computer-based operations in accordance with the present disclosure.

### DETAILED DESCRIPTION OF THE DRAWINGS

The technique described in Non-Patent Literature 1 merely changes the facial expression of the virtual character so as to follow a change in the shape of the user's (performer's) face, and therefore it may be impossible to reflect the user's facial expression that is difficult to actually express to the facial expression of the virtual character. Accordingly, it is difficult for this technique to express impressive facial expressions as described above in the facial expression of a virtual character.

Further, the technique described in Non-Patent Literature 2 needs to assign a facial expression to be expressed in the virtual character to each of a plurality of flick directions in advance. This requires the user (performer) to recognize all the facial expressions prepared. Furthermore, the total number of facial expressions that are assigned to the plurality of flick directions and can be used at once is limited to less than ten, which is insufficient.

The inventors of the present application have developed the technologies and techniques in this document to address the above issues. Accordingly, the embodiments disclosed in the present application provide a computer program, a server, a terminal device, a system, and a method for causing a virtual character to give a facial expressions that the performer intends to express using a simple method.

A computer program according to an aspect of the present disclosure causes a processor to obtain, an amount of change of each of a plurality of specific parts related to a performer, based on data on the performer obtained by a sensor, to obtain, for at least one specific feeling of a plurality of specific feelings associated with each of the specific parts, a first score based on the amount of change of the specific part, to obtain a second score based on a sum of the first scores obtained for the individual specific feelings for each of the plurality of specific feelings, and to select a specific feeling having a second score exceeding a threshold from among the plurality of specific feelings as a feeling expressed by the performer.

A terminal device according to an aspect of the present disclosure includes a processor, wherein the processor executes computer-readable instructions to obtain, an amount of change of each of a plurality of specific parts related to a performer, based on data on the performer obtained by a sensor, to obtain, for at least one specific feeling of a plurality of specific feelings associated with each of the specific parts, a first score based on the amount of change of the specific part, to obtain a second score based on a sum of the first scores obtained for the individual specific feelings for each of the plurality of specific feelings, and to select a specific feeling having a second score exceeding a threshold from among the plurality of specific feelings as a feeling expressed by the performer.

A server according to an aspect of the present disclosure includes a processor, wherein the processor executes computer-readable instructions to obtain, an amount of change of each of a plurality of specific parts related to a performer, based on data on the performer obtained by a sensor, to obtain, for at least one specific feeling of a plurality of specific feelings associated with each of the specific parts, a first score based on the amount of change of the specific part, to obtain a second score based on a sum of the first scores obtained for the individual specific feelings for each of the plurality of specific feelings, and to select a specific feeling having a second score exceeding a threshold from among the plurality of specific feelings as a feeling expressed by the performer.

A method according to an aspect of the present disclosure is executed by a processor that executes computer-readable instructions, the method including a change-amount acquisition step of obtaining, an amount of change of each of a plurality of specific parts related to a performer, based on data on the performer obtained by a sensor, a first-score acquisition step of obtaining, for at least one specific feeling of a plurality of specific feelings associated with each of the specific parts, a first score based on the amount of change of the specific part, a second-score acquisition step of obtaining a second score based on a sum of the first scores obtained for the individual specific feelings for each of the plurality of specific feelings, and a selection step of selecting a specific feeling having a second score exceeding a threshold from among the plurality of specific feelings as a feeling expressed by the performer.

A system according to an aspect of the present disclosure includes a first device including a first processor and a second device including a second processor and configured to connect to the first device via a communication line, wherein the first processor included in the first device executes computer-readable instructions to execute at least one of a change-amount acquisition process of obtaining, an amount of change of each of a plurality of specific parts related to a performer, based on data on the performer obtained by a sensor, a first-score acquisition process of obtaining, for at least one specific feeling of a plurality of specific feelings associated with each of the specific parts, a first score based on the amount of change of the specific part, a second-score acquisition process of obtaining a second score based on a sum of the first scores obtained for the individual specific feelings for each of the plurality of specific feelings, a selection process of selecting a specific feeling having a second score exceeding a threshold from among the plurality of specific feelings as a feeling expressed by the performer, and an image generation process of generating an image based on the selected feeling, in sequence from the change-amount acquisition process, wherein, when a remaining process that is not executed by the first processor is present, the second processor included in the second device executes the remaining process by executing computer-readable instructions.

A method according to another aspect of the present disclosure is executed by a system including a first device including a first processor and a second device including a second processor and configured to connect to the first device via a communication line, the method including a change-amount acquisition step of obtaining, an amount of change of each of a plurality of specific parts related to a performer, based on data on the performer obtained by a sensor, a first-score acquisition step of obtaining, for at least one specific feeling of a plurality of specific feelings associated with each of the specific parts, a first score based on the amount of change of the specific part, a second-score acquisition step of obtaining a second score based on a sum of the first scores obtained for the individual specific feelings for each of the plurality of specific feelings, a selection step of selecting a specific feeling having a second score exceeding a threshold from among the plurality of specific feelings as a feeling expressed by the performer, and an image generation step of generating an image based on the selected feeling, in sequence from the change-amount acquisition process, wherein the first processor included in the first device executes computer-readable instructions to execute at least one step from the first-score acquisition step, and wherein, when a remaining step that is not executed by the first processor is present, the second processor included in the second device executes the remaining step by executing computer-readable instructions.

Various embodiments of the present disclosure will be described hereinbelow with reference to the accompanying drawings. Components common in the drawings are denoted by the same reference signs. Note that a component illustrated in one drawing is sometimes omitted in another drawing for the convenience of description. It is also to be noted that the accompanying drawings are not always illustrated in a correct scale.

1. Example of Communication System

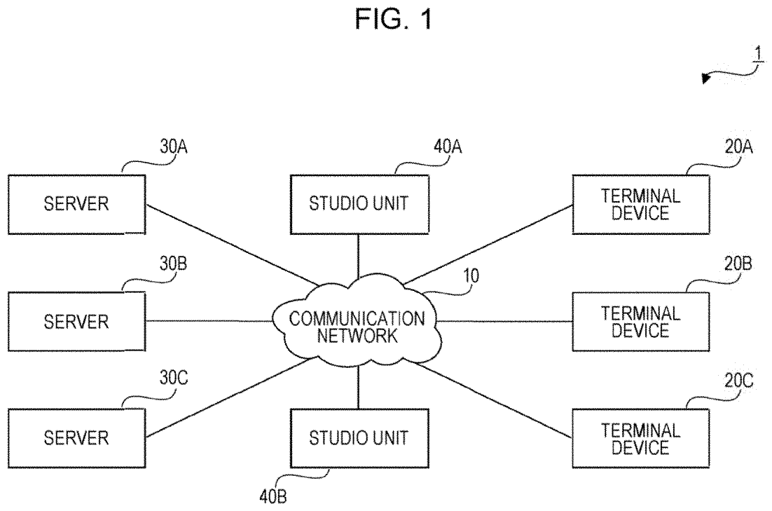

FIG. 1 is a block diagram illustrating an example of the configuration of a communication system 1 according to an embodiment. As illustrated in FIG. 1, the communication system 1 includes one or more terminal devices 20 connected to a communication network 10 and one or more servers 30 connected to the communication network 10. FIG. 1 illustrates three terminal devices 20A to 20C as examples of the terminal device 20, and three servers 30A to 30C as examples of the server 30. Alternatively, one or more terminal devices 20 other than those can be connected to the communication network 10, and one or more servers 30 other than those can be connected to the communication network 10.

The communication system 1 may include one or more studio units 40 connected to the communication network 10. FIG. 1 illustrates two studio units 40A and 40B as examples of the studio unit 40. Alternatively, one or more studio units 40 other than those can be connected to the communication network 10.

According to a “first aspect”, in the communication system 1 illustrated in FIG. 1, the terminal device 20 (for example, the terminal device 20A) that is operated by a performer to execute a predetermined application (for example, an application for delivering moving images) can obtain data on the performer facing the terminal device 20A. Furthermore, the terminal device 20 can transmit a moving image of a virtual character whose facial expression is changed according to the obtained data to the server 30 (for example, the server 30A) via the communication network 10. The server 30A can deliver the moving image of the virtual character received from the terminal device 20A to the other one or more terminal devices 20 that have sent a request to execute a predetermined application (for example, an application for viewing moving images) to deliver the moving image) via the communication network 10. Instead of the configuration in which the terminal device 20 transmits the moving image of the virtual character whose facial expression has been changed to the server 30, a configuration in which the terminal device 20 transmits data on the performer or data based thereon to the server 30 may be employed. In this case, the server 30 can generate a moving image of the virtual character whose facial expression has been changed according to the data received from the terminal device 20. Alternatively, the terminal device 20 may transmit data on the performer or data based thereon to the server 30, and the server 30 may transmit the data on the performer or the data based thereon, received from the terminal device 20, to another terminal device (a viewer's terminal device) 20. In this case, this other terminal device 20 can generate or play back a moving image of the virtual character whose facial expression has been changed according to the data received from the server 30.

According to a “second aspect”, in the communication system 1 illustrated in FIG. 1, the server 30 (for example, the server 30B) installed in a studio or elsewhere can obtain data on a performer in the studio or elsewhere. The server 30 can deliver a moving image of the virtual character whose facial expression has been changed according to the obtained data to one or more terminal devices 20 that have sent a request to execute a predetermined application (for example, an application for viewing moving images) to deliver the moving image) via the communication network 10.

According to a “third aspect”, in the communication system 1 illustrated in FIG. 1, the studio unit 40 installed in a studio or elsewhere can obtain data on a performer in the studio or elsewhere. The studio unit 40 can generate a moving image of a virtual character whose facial expression has been changed according to the obtained data to the server 30. The server 30 can deliver the moving image received from the studio unit 40 to one or more terminal devices 20 that have sent a request to execute a predetermined application (for example, an application for viewing moving images) to deliver the moving image) via the communication network 10. Instead of the configuration in which the studio unit 40 transmits the moving image of the virtual character whose facial expression has been changed to the server 30, a configuration in which the studio unit 40 transmits data on the performer or data based thereon to the server 30 may be employed. In this case, the server 30 can generate a moving image of the virtual character whose facial expression has been changed according to the data received from the studio unit 40. Alternatively, the studio unit 40 may transmit data on the performer or data based thereon to the server 30, and the server 30 may transmit the data on the performer or the data based thereon, received from the studio unit 40, to the terminal device (viewer's terminal device) 20. In this case, this terminal device 20 can generate or play back a moving image of the virtual character whose facial expression has been changed according to the data received from the server 30.

The communication network 10 includes a mobile phone network, a wireless local area network (LAN), a wireless fixed telephone network, Internet, an intranet and/or Ethernet, without limitation thereto.

The terminal device 20 can execute, for example, the operation of obtaining data on the performer by executing an installed specific application. The terminal device 20 can also execute the operation of transmitting a moving image of a virtual character whose facial expression has been changed according to the obtained data to the server 30 via the communication network 10. The terminal device 20 can execute similar operations by receiving and displaying a web page from the server 30 by executing an installed web browser.

The terminal device 20 includes a smartphone, a tablet, a mobile phone (feature phone), a personal computer, and any other terminal devices capable of such operations.

In the “first aspect”, the server 30 can execute an installed specific application to function as an application server. This allows the server 30 to execute the operation of receiving a moving image of the virtual character from each terminal device 20 via the communication network 10 and delivering the received moving image (together with another moving image) to each terminal device 20 via the communication network 10. The server 30 can execute similar operations via a web page for transmission to each terminal device 20 by executing an installed specific application to function as a web server.

In the “second aspect”, the server 30 can execute an installed specific application to function as an application server. This allows the server 30 to execute the operation of obtaining data on a performer in a studio or elsewhere in which the server 30 is installed and delivering a moving image of a virtual character whose facial expression has been changed according to the obtained data (together with another moving image) to each terminal device 20 via the communication network 10. The server 30 can also execute the installed specific application to function as a web server. This allows the server 30 to execute a similar operation via a web page for transmission to each terminal device 20. The server 30 can also execute the installed specific application to function as an application server. This allows the server 30 to execute the operation of obtaining (receiving) a moving image of a virtual character whose facial expression has been changed according to data on the performer in a studio or elsewhere from the studio unit 40 installed in the studio or elsewhere. The server 30 can execute the operation of delivering the moving image to each terminal device 20 via the communication network 10.

The studio unit 40 can function as an information processing apparatus that executes an installed specific application. This allows the studio unit 40 to obtain data on the performer in a studio or elsewhere in which the studio unit 40 is installed. The studio unit 40 can also transmit a moving image of the virtual character whose facial expression has been changed according to the obtained data (together with another moving image) to the server 30 via the communication network 10.

2. Hardware Configurations of the Devices

Next, an example of the hardware configuration of each of the terminal device 20, the server 30, and the studio unit 40 will be described.

2.1. Hardware Configuration of Terminal Device 20

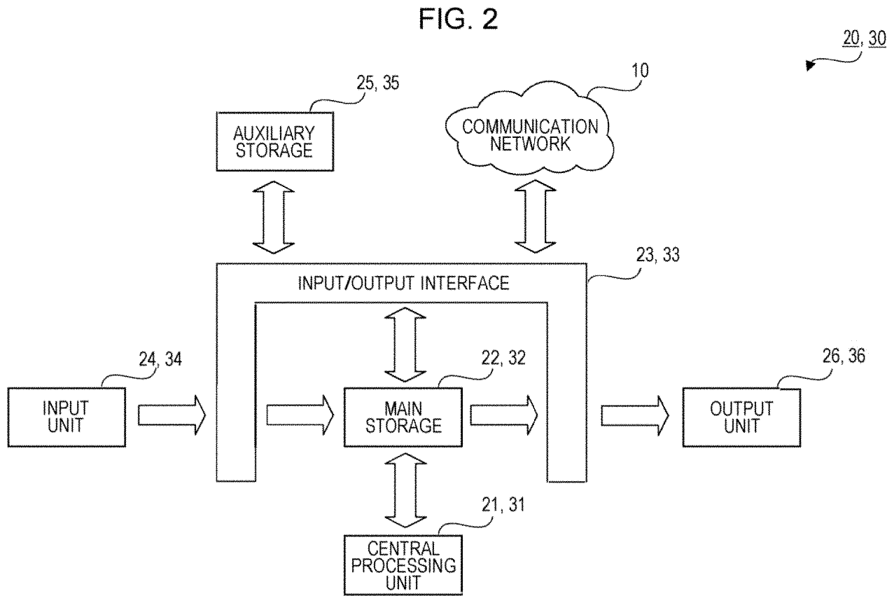

An example of the hardware configuration of each terminal device 20 will be described with reference to FIG. 2. FIG. 2 is a block diagram illustrating, in outline, an example of the hardware configuration of the terminal device 20 (the server 30) illustrated in FIG. 1. In FIG. 2, the reference signs in brackets are related to each server 30.

As illustrated in FIG. 2, each terminal device 20 may mainly include a central processing unit 21, a main storage 22, an input/output interface 23, an input unit 24, an auxiliary storage 25, and an output unit 26. These units are connected together via a data path and/or a control path.

The central processing unit 21 is referred to as “CPU” and calculates instructions and data stored in the main storage 22 and stores the results of the calculation in the main storage 22. The central processing unit 21 can also controls the input unit 24, the auxiliary storage 25, the output unit 26, and so on via the input/output interface 23. The terminal device 20 may include one or more central processing units 21.

The main storage 22 is referred to as “memory”, which stores instructions and data received from the input unit 24, the auxiliary storage 25, the communication network 10, and so on (the server 30 and so on) via the input/output interface 23 and the results of calculation of the central processing unit 21. The main storage 22 may include a random-access memory (RAM), a read-only memory (ROM), a flash memory, and any other memories.

The auxiliary storage 25 has a capacity larger than that of the main storage 22. The auxiliary storage 25 stores instructions and data (computer programs) constituting the specific application or the web browser. The instructions and data (computer programs) can be transmitted to the main storage 22 via the input/output interface 23 under the control of the central processing unit 21. The auxiliary storage 25 may include a magnetic disk, an optical disk, and any other storages.

The input unit 24 is a unit for receiving data from the outside and includes a touch panel, buttons, a keyboard, and a mouse and/or a sensor, without limitation thereto. The sensor may include a first sensor including one or more cameras and a second sensor including one or more microphones without limitation thereto, as described later.

The output unit 26 may include a display, a touch panel and/or a printer without limitation thereto.

Such a hardware configuration allows the central processing unit 21 to control the output unit 26 via the input/output interface 23 by loading instructions and data (computer programs) constituting a specific application stored in the auxiliary storage 25 to the main storage 22 one after another and calculating the loaded instructions and data, or to transmit and receive various pieces of information to and from other devices (for example, the server 30 and the other terminal devices 20) via the input/output interface 23 and the communication network 10.

This allows the terminal device 20 to execute the operation of obtaining data on the performer and transmitting a moving image of the virtual character whose facial expression has been changed according to the obtained data to the server 30 via the communication network 10 (including various operations described in detail later) by executing the installed specific application. Alternatively, the terminal device 20 can execute similar operations by receiving and displaying a web page from the server 30 by executing an installed web browser.

The terminal device 20 may include one or more microprocessors and/or graphics processing units (GPUs) in place of or together with the central processing unit 21.

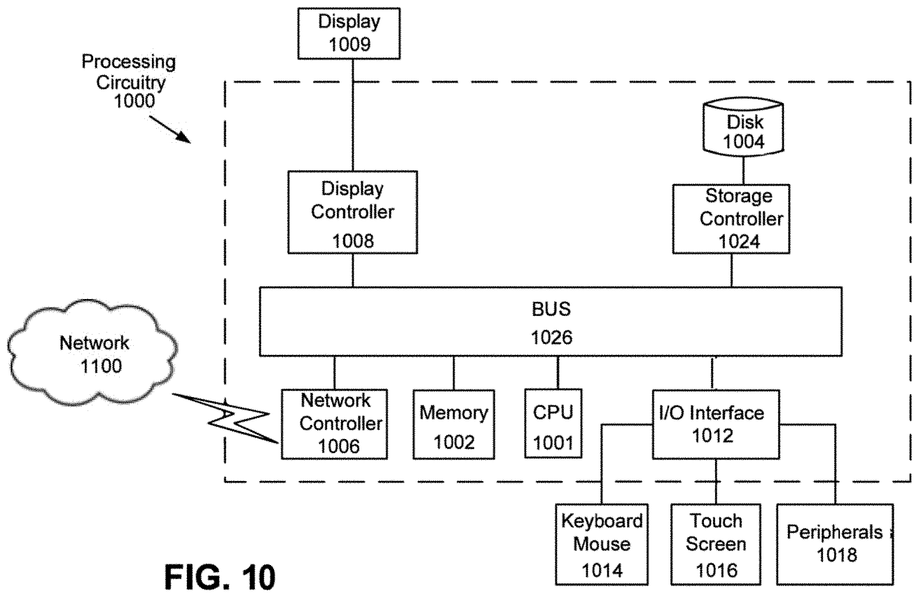

An additional hardware discussion of terminal device 20 including central processing unit 21, main storage 22, input/output interface 23, input unit 24, auxiliary storage 25, and output unit 26 will be provided later with respect to the processing circuitry illustrated in FIG. 10.

2.2. Hardware Configuration of Server 30

An example of the hardware configuration of each server 30 will be described with reference to FIG. 2. The hardware configuration of each server 30 may be the same as the hardware configuration of each terminal device 20 described above. Accordingly, the reference signs of the components of each server 30 are illustrated in brackets in FIG. 2.

As illustrated in FIG. 2, each server 30 may mainly include a central processing unit 31, a main storage 32, an input/output interface 33, an input unit 34, an auxiliary storage 35, and an output unit 36. These units are connected to one another with a data bus and/or a control bus.

The central processing unit 31, the main storage 32, the input/output interface 33, the input unit 34, the auxiliary storage 35, and the output unit 36 are respectively substantially the same as the central processing unit 21, the main storage 22, the input/output interface 23, the input unit 24, the auxiliary storage 25, and the output unit 26 included in each terminal device 20 described above.

Such a hardware configuration allows the central processing unit 31 to control the output unit 36 via the input/output interface 33 by loading instructions and data (computer programs) constituting a specific application stored in the auxiliary storage 35 to the main storage 32 one after another and calculating the loaded instructions and data, or to transmit and receive various pieces of information to and from other devices (for example, the terminal devices 20) via the input/output interface 33 and the communication network 10.

This allows, in the “first aspect”, the server 30 to execute the installed specific application to function as an application server. This allows the server 30 to execute the operation of receiving a moving image of the virtual character from each terminal device 20 via the communication network 10 and delivering the received moving image (together with another moving image) to each terminal device 20 via the communication network 10 (including various operations described in detail later). The server 30 can also execute the installed specific application to function as a web server. This allows the server 30 to execute similar operation via a web page transmitted to each terminal device 20.

In the “second aspect”, the server 30 can execute an installed specific application to function as an application server. This allows the server 30 to execute the operation of obtaining data on a performer in a studio or elsewhere in which the server 30 is installed. The server 30 can also execute the operation of delivering a moving image of a virtual character whose facial expression has been changed according to the obtained data (together with another moving image) to each terminal device 20 via the communication network 10. The server 30 can also execute the installed specific application to function as a web server. This allows the server 30 to execute a similar operation via a web page for transmission to each terminal device 20.

In the “third aspect”, the server 30 can execute an installed specific application to function as an application server. This allows the server 30 to execute the operation of obtaining (receiving) data on a performer in a studio or elsewhere in which the studio unit 40 is installed (together with another moving image) from the studio unit 40 via the communication network 10. The server 30 can also execute the operation of delivering the image to each terminal device 20 (including various operations described in detail layer) via the communication network 10.

The server 30 may include one or more microprocessors and/or graphics processing units (GPUs) in place of or together with the central processing unit 31.

An additional hardware discussion of server 30 including central processing unit 31, main storage 32, input/output interface 33, input unit 34, auxiliary storage 35, and output unit 36 will be provided later with respect to the processing circuitry illustrated in FIG. 10.

2.3. Hardware Configuration of Studio Unit 40

The studio unit 40 can be implemented by an information processing apparatus, such as a personal computer, and can mainly include a central processing unit, a main storage, an input/output interface, an input unit, an auxiliary storage, and an output unit, like the terminal device 20 and the server 30. These units are connected to one another with a data bus and/or a control bus.

The studio unit 40 can function as an information processing apparatus that executes an installed specific application. This allows the studio unit 40 to obtain data on the performer in a studio or elsewhere in which the studio unit 40 is installed. The studio unit 40 can also transmit a moving image of the virtual character whose facial expression has been changed according to the obtained data (together with another moving image) to the server 30 via the communication network 10.

3. Functions of Devices

Next, examples of the respective functions of the terminal device 20 and the server 30 will be described.

3.1. Functions of Terminal Device 20

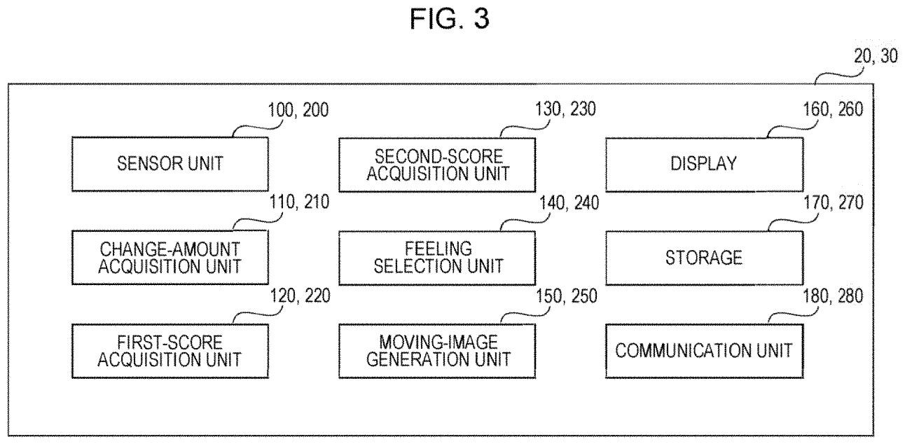

An example of the functions of the terminal device 20 will be described with reference to FIG. 3. FIG. 3 is a block diagram illustrating, in outline, an example of the functions of the terminal device 20 (the server 30) illustrated in FIG. 1 (in FIG. 3, the reference signs in brackets are given for the server 30, as will be described later).

As illustrated in FIG. 3, the terminal device 20 may include a sensor unit 100, a change-amount acquisition unit 110, a first-score acquisition unit 120, a second-score acquisition unit 130, and a feeling selection unit 140. The sensor unit 100 can obtain data on the performer's face with a sensor. The change-amount acquisition unit 110 can obtain the amount of change of each of a plurality of specific parts related to the performer on the basis of the data obtained from the sensor unit 100. The first-score acquisition unit 120 can obtain, for at least one of specific feelings associated with the individual specific feelings, a first score based on the amount of change of the specific part. The second-score acquisition unit 130 can obtain, for each of the plurality of specific feelings, a second score based on the sum of the first scores obtained for the individual specific feelings. The feeling selection unit 140 can select a specific feeling having a second score exceeding a threshold among the plurality of specific feelings as a feeling expressed by the performer.

The terminal device 20 may further include a moving-image generation unit 150, a display 160, a storage 170, and a communication unit 180. The moving-image generation unit 150 can generate a moving image in which the feeling selected by the feeling selection unit 140 is expressed in a virtual character. The display 160 can display the moving image generated by the moving-image generation unit 150. The storage 170 can store the moving image generated by the moving-image generation unit 150. The communication unit 180 can, for example, transmit the moving image generated by the moving-image generation unit 150 to the server 30 via the communication network 10.

3.1.1. Sensor Unit 100

The sensor unit 100 includes various types of sensor, such as a camera and/or microphone. The sensor unit 100 can obtain data (for example, an image and/or voice) of the performer facing the sensor unit 100 and can execute image processing on the data. Specifically, for example, the sensor unit 100 can obtain image data on the performer every unit time interval using various types of camera and can specify the positions of a plurality of specific parts related to the performer every unit time interval using the obtained image data. The plurality of specific parts may include the performer's right eye, left eye, right cheek, left cheek, nose, right eyebrow, left eyebrow, chin, right ear, left ear, any other parts. The unit time interval can be set or changed to any length by the user, the performer, or the like at any timing via a user interface.

In an embodiment, the sensor unit 100 may include an RGB camera that creates an image using visible light and a near-infrared camera that creates an image using near-infrared light. An example of these cameras is a camera included in an iPhone X® TrueDepth camera. The TrueDepth may be the camera disclosed in https://developer.apple.com/documentation/arkit/arfaceanchor, which is incorporated in this specification by reference in its entirety.

For the RGB camera, the sensor unit 100 can generate data (for example, a Moving Picture Experts Group (MPEG) file) in which images captured by the RGB camera are recorded over a unit time interval in association with a time code. The time code indicates the capture time. Furthermore, the sensor unit 100 can also generate data in which a predetermined number of numerical values indicating depths obtained by the near-infrared camera is recorded over a unit time interval in association with a time code. An example of the predetermined number is 51. An example of the numerical values indicating the depths is a floating decimal point value. An example of the data generated by the sensor unit 100 is a tab-separated values (TSV) file. The TSV file is a file of a format for recording a plurality of data by separating the data with tabs.

For the near-infrared camera, specifically, a dot projector radiates infrared laser beams containing a dot pattern to the performer's face, and the near-infrared camera captures the infrared dots that are projected to the performer's face and reflected therefrom and generates an image of the captured infrared dots. The sensor unit 100 compares the image captured by the near-infrared camera with a dot pattern image radiated from the dot projector and registered in advance. This allows the sensor unit 100 to calculate the depths of the individual points using the displacements of the positions of the individual points in the images. The points are sometimes referred to as specific parts. The number of points in the images is, for example, 51. The depth of each point is the distance between the point (specific part) and the near-infrared camera. The sensor unit 100 can generate data in which the values indicating the depths calculated in this way are recorded over a unit time interval in association with a time code as described above.

This allows the sensor unit 100 to obtain, as data on the performer, moving images, such as MPEG files, and the positions (the coordinates) of the individual specific parts in association with a time code every unit time interval.

According to this embodiment, the sensor unit 100 can obtain data on the individual specific parts of, for example, the upper body (for example, the face) of the performer, containing MPEG files in which the upper body of the performer is captured and the positions (coordinates) of the specific parts every unit time interval. Specifically, for example, for the specific part of the right eye, the sensor unit 100 can obtain information indicating the position (coordinates) of the right eye every unit time interval. For example, for the specific part of the chin, the sensor unit 100 can obtain information indicating the position (coordinates) of the chin every unit time interval.

In another embodiment, the sensor unit 100 can use the technique of Augmented Faces. Augmented Faces disclosed in https://developers.google.com/ar/develop/java/augmented-faces/ can be used, which is incorporated in this specification by reference in its entirety.

The use of Augmented Faces allows the sensor unit 100 to obtain the following items every unit time interval using images captured by the camera.

i. The physical center position of the performer's skull

ii. A face mesh containing hundreds of apexes constituting the performer's face and defined with respect to the center position

iii. The positions of specific parts (for example, the right cheek, the left cheek, and the nose) of the performer's face identified on the basis of items i and ii

The sensor unit 100 can obtain the positions (coordinates) of specific parts of the upper body (for example, the face) of the performer every unit time interval.

3.1.2. Variation-Amount Acquisition Unit 110

The change-amount acquisition unit 110 obtains the amount of change of each of a plurality of specific parts related to the performer on the basis of data on the performer obtained by the sensor unit 100. Specifically, the change-amount acquisition unit 110 can obtain, for example, for the specific part of the right cheek, the difference between the position (coordinates) obtained in unit time interval 1 and the position (coordinates) obtained in unit time interval 2. This allows the change-amount acquisition unit 110 to obtain the amount of change of the specific part of the right cheek between the unit time interval 1 and the unit time interval 2. The change-amount acquisition unit 110 can also obtain the amount of change of another specific part.

The change-amount acquisition unit 110 can use the difference between a position (coordinates) obtained in any unit time interval and a position (coordinates) obtained in any another unit time interval to obtain the amount of change of each specific part. The unit time interval may be fixed, variable, or a combination thereof

3.1.3. First-Score Acquisition Unit 120

The first-score acquisition unit 120 obtains, for at least one specific feeling of a plurality of specific feelings associated with each specific part (for example, every freely settable unit time interval), a first score based on the amount of change of the specific part. Specifically, the first-score acquisition unit 120 can use a plurality of specific feelings, such as “fear”, “surprise”, “sorrow”, “hatred”, “anger”, “expectation”, “joy”, “trust”, and any other specific feelings.

For example, for the specific part of the corner of the right eye, the first-score acquisition unit 120 can obtain, for the specific feeling of “joy” associated with the specific part, a first score based on the amount of change of the specific part per unit time interval. For the specific feeling of “sorrow” associated with this specific part, the first-score acquisition unit 120 can obtain a first score based on the amount of change of this specific part per unit time interval. Here, even if the amount of change of the specific part of the corner of the right eye per unit time interval is the same (for example, X1), the first-score acquisition unit 120 can obtain, for the specific feeling of “joy”, a high first score on the basis of the amount of change (X1), and for the specific feeling of “sorrow”, a low first score on the basis of the amount of change (X1).

The first-score acquisition unit 120 can obtain, also for another specific part, as for the specific part of the corner of the right eye, a first score based on the amount of change of this specific part per unit time interval for at least one specific feeling associated with the specific part. This allows the first-score acquisition unit 120 to obtain a first score for each of a plurality of specific feelings every unit time interval.

It is assumed that two specific feelings B1 and B5 are associated with a specific part A1, and three specific feelings B3, B5, and B8 are associated with a specific part A5. In this case, for the specific feeling B5, at least a first score based on the amount of change of the specific part A1 and a first score based on the amount of change of the specific part A5 are obtained. Thus, there is a possibility that first scores based on the amount of change of one or more specific parts may be calculated for the same specific feeling.

3.1.4. Second-Score Acquisition Unit 130

The second-score acquisition unit 130 obtains a second score based on the sum of first scores obtained for a plurality of specific feelings (every freely settable unit time interval). Specifically, if first scores based on the amounts of change of a plurality of specific parts are obtained for one specific feeling, the second-score acquisition unit 130 can obtain the sum of the first scores as the second score of the specific feeling. If only one first score based on the amount of change of one specific part is obtained for another specific feeling, the second-score acquisition unit 130 can use the first score as the second score for the other specific feeling.

In an embodiment, the second-score acquisition unit 130 can also obtain a value obtained by multiplying the sum of first scores based on the amount of change of one or more specific parts by a predetermined factor as a second score for the specific feeling, instead of obtaining the sum of the first scores as a second score for the specific feeling. The second-score acquisition unit 130 may use the value obtained by multiplying the sum of first scores by a predetermined factor for all of specific feelings or one or more selected specific feelings.

3.1.5. Feeling Selection Unit 140

The feeling selection unit 140 selects a specific feeling having a second score exceeding a threshold from among a plurality of specific feelings (for example, every freely settable unit time interval) as a feeling expressed by the performer. Specifically, the feeling selection unit 140 can select a specific feeling having a second score exceeding a set threshold among the second scores obtained for a plurality of specific feelings every unit time interval as a feeling expressed by the performer in the unit time interval. The threshold may be variable, fixed, or a combination thereof

3.1.6. Moving-Image Generation Unit 150

The moving-image generation unit 150 can generate a moving image in which a feeling selected by the feeling selection unit 140 (for example, every freely settable unit time interval) is expressed in a virtual character. The moving image may be a still image. Specifically, it is assumed that a second score exceeding a threshold is present in one unit time interval, so that a feeling having the second score is selected from a plurality of specific feelings by the feeling selection unit 140. In this case, the moving-image generation unit 150 can generate a moving image in which a facial expression corresponding to the selected feeling is expressed in a virtual character. The facial expression corresponding to the selected feeling may be a facial expression that the performer cannot actually express. Examples of the impossible facial expression include a facial expression in which both eyes are expressed by X and a facial expression in which the mouse pops out like an animation. In this case, specifically, the moving-image generation unit 150 can generate a moving image in which a cartoon-like moving image is superposed on the actual facial expression of the performer and/or a moving image in which part of the actual facial expression of the performer is rewritten. Examples of the cartoon-like moving image include a moving image in which both eyes change from a normal state to X and a moving image in which a mouse changes from a normal state to a popped-out state.

In another embodiment, the moving-image generation unit 150 can generate a moving image in which a feeling selected by the feeling selection unit 140 is expressed in a virtual character using a technique called “Blend Shapes”. The use of this technique allows the moving-image generation unit 150 to adjust the individual parameters of one or more specific parts corresponding to a specific feeling selected by the feeling selection unit 140 from among the specific parts of the face. This allows the moving-image generation unit 150 to generate a cartoon-like moving image as described above.

“Blend Shapes” may be the technique described in the website specified by the following URL. https://developer.apple.com/documentation/arkit/arfaceanchor/2928251-blendshapes

The content described in this website is incorporated in this specification by reference in its entirety.

In another unit time interval, no second score exceeding a threshold is present, so that no feelings may be selected by the feeling selection unit 140 from among a plurality of specific feelings. An example is a case in which the performer has not changed the facial expression to the extent that any of the second scores exceeds the threshold when the performer simply blinks while keeping a straight face or when the performer looks down while keeping a straight face. In this case, the moving-image generation unit 150 can generate a moving image of a virtual character following the action of the performer. Examples of the moving image of the virtual character include a moving image in which the virtual character simply blinks while keeping its straight face, a moving image in which the virtual character simply looks down while keeping its straight face, and a moving image in which the virtual character moves the mouse or eyes according to the motion of the performer. A method for generating such moving images is well known, and the details thereof will be omitted. Such a well-known technique includes “Blend Shapes” described above. In this case, the moving-image generation unit 150 can adjust the parameters of one or more specific parts of a plurality of specific parts of the face corresponding to the motion of the performer. This allows the moving-image generation unit 150 to generate a moving image of a virtual character following the motion of the performer.

This allows the moving-image generation unit 150, for a unit time interval in which the performer does not change the facial expression to the extent that any of second scores exceeds the threshold, to generate a moving image of a virtual character following the motion and the facial expression of the performer. In contrast, for a unit time interval in which the performer has changed the facial expression to the extent that any of second scores exceeds the threshold, the moving-image generation unit 150 can generate a moving image of a virtual character in which a facial expression corresponding to the specific feeling of the performer is expressed.

3.1.7. Display 160, Storage 170, and Communication Unit 180

The display 160 can display moving images generated by the moving-image generation unit 150 (for example, every freely settable unit time interval) on the display (touch panel) of the terminal device 20 and/or a display (of another terminal device) connected to the terminal device 20. The display 160 can display moving images generated by the moving-image generation unit 150 in sequence in parallel with the operation of the sensor unit 100 to obtain data on the performer. The display 160 can also display a moving image generated by the moving-image generation unit 150 and stored in the storage 170 on the display according to an instruction of the performer in parallel with the operation of obtaining the data. The display 160 can also generate a moving image received by the communication unit 180 from the server 30 via the communication network 10 and (stored in the storage 170) in parallel with the operation of obtaining the data.

The storage 170 can store, for example, a moving image generated by the moving-image generation unit 150 and/or a moving image received from the server 30 via the communication network 10.

The communication unit 180 can also transmit a moving image generated by the moving-image generation unit 150 (and stored in the storage 170) to the server 30 via the communication network 10. The moving image may be a still image. The communication unit 180 can also receive an image transmitted from the server 30 via the communication network 10 (and store the image in the storage 170).

The operations of the components described above can be executed by the terminal device 20 that executes predetermined applications installed in the performer's terminal device 20. An example of the predetermined applications is an application for delivering moving images. Alternatively, the above operations can be executed by the performer's terminal device 20 also by accessing a website provided by the server 30 using a browser installed in the terminal device 20.

3.2. Functions of Server 30

Specific examples of the functions of the server 30 will be described with reference to FIG. 3. Part of the functions of the terminal device 20 described above may be used as the functions of the server 30. Accordingly, the reference signs of the components of the server 30 are illustrated in the brackets in FIG. 3.

In the “second aspect”, the server 30 may include a sensor unit 200 to a communication unit 280, which are respectively the same as the sensor unit 100 to the communication unit 180 described for the terminal device 20, except the following differences.

In the “second aspect”, it is assumed that the server 30 is disposed in a studio or elsewhere and is used by a plurality of performers (users). Accordingly, various sensors constituting the sensor unit 200 may be opposed to the performers in a space where the performers give performances in a studio or elsewhere in which the server 30 is installed. Similarly, a display or a touch panel constituting the display 160 may also be opposed to or near the performers in a space where the performers give performances in a studio or elsewhere in which the server 30 is installed.

The communication unit 280 can deliver a file in which moving images stored in the storage 270 in association with the individual performers to the plurality of terminal devices 20 via the communication network 10. Each of the terminal devices 20 can execute an installed predetermined application to transmit a signal (a request signal) that requests delivery of a desired moving image to the server 30. This allows each of the terminal devices 20 to receive the desired moving image from the server 30 via the predetermined application. An example of the predetermined application is an application for viewing moving images.

The information to be stored in the storage 270 may be stored in one or more other servers (storages) 30 capable of communication with the server 30 via the communication network 10. An example of the information stored in the storage 270 is a file in which the moving images are stored.

In the “first aspect”, the sensor unit 200 to the moving-image generation unit 250 used in the “second aspect” can be used as options. In addition to the above operations, the communication unit 280 can store the file in which the moving images transmitted from the individual terminal device 20 and received via the communication network 10 is stored in the storage 270 and then deliver the file to the terminal devices 20.

In the “third aspect”, the sensor unit 200 to the moving-image generation unit 250 used in the “second aspect” can be used as options. In addition to the above operations, the communication unit 280 can store a file in which moving images transmitted from the studio unit 40 and received vie the communication network 10 are stored in the storage 270 and then deliver the file to the terminal devices 20.

3.3. Functions of Studio Unit 40

The studio unit 40 has the same functions as the functions of the terminal device 20 or the server 30 illustrated in FIG. 3 and can perform the same operations as those of the terminal device 20 or the server 30. However, the communication unit 180 (280) can transit a moving image generated by the moving-image generation unit 150 (250) and stored in the storage 170 (270) to the server 30 via the communication network 10.

In particular, various sensors constituting the sensor unit 100 (200) may be opposed to the performer in a space where the performer gives a performance in a studio or elsewhere in which the studio unit 40 is installed. Similarly, the display or the touch panel constituting the display 160 (260) may also be opposed to or near the performer in a space where the performer gives a performance.

3.4. Operation of Entire Communication System 1

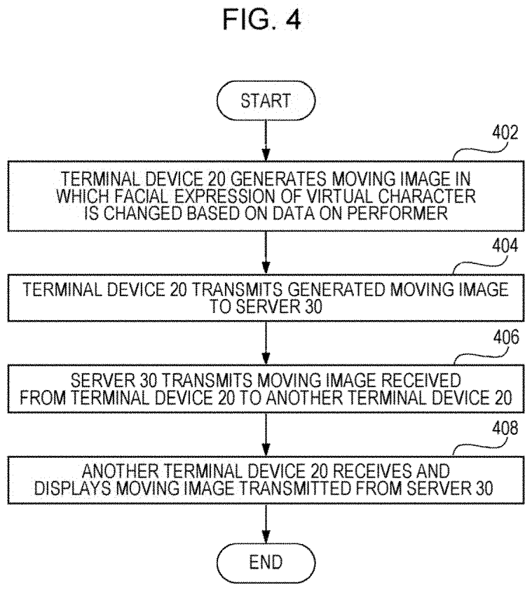

Next, a specific example of the operation of the entire communication system 1 with the above configuration will be described with reference to FIG. 4. FIG. 4 is a flowchart illustrating an example of operations performed by the entire communication system 1 illustrated in FIG. 1.

First, at step (hereinafter referred to as “ST”) 402, the terminal device 20 (in the case of the first aspect), the server 30 (in the case of the second aspect), or the studio unit 40 (in the case of the third aspect) generates a moving image in which the facial expression of the virtual character has been changed on the basis of data on the performer.

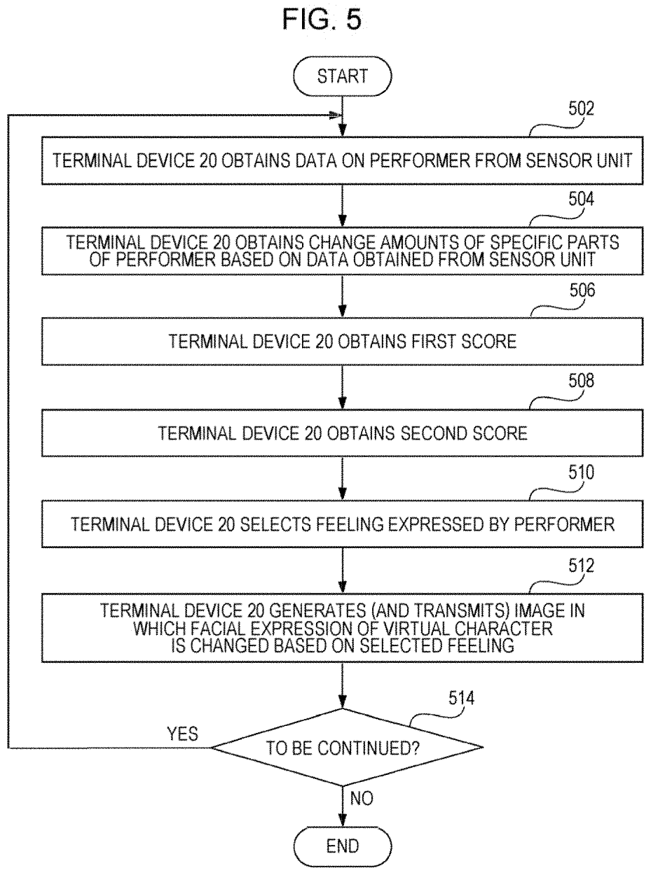

Next at ST404, the terminal device 20 (in the case of the first aspect) or the studio unit 40 (in the case of the third aspect) transmits the generated moving image to the server 30. In the second aspect, the server 30 does not execute ST404 or can transmit the generated moving image to another server 30. Specific examples of the operations executed at ST402 and ST404 will be described later with reference to FIG. 5, for example.

At ST406, in the case of the first aspect, the server 30 can transmit the moving image received from the terminal device 20 to another terminal device 20. In the case of the second aspect, the server 30 (or another server 30) can transmit the moving image received from the terminal device 20 to another terminal device 20. In the case of the third aspect, the server 30 can transmit the moving image received from the studio unit 40 to another terminal device 20.

At ST408, in the case of the first aspect or the third aspect, the other terminal device 20 can receive the moving image transmitted from the server 30 and can display the moving image on the display or the like of the terminal device 20 or a display or the like connected to the terminal device 20. In the case of the second aspect, the other terminal device 20 can receive the moving image transmitted from the server 30 or another server 30 and can display the moving image on the display or the like of the terminal device 20 or a display or the like connected to the terminal device 20.

5. Operations for Generating and Transmitting Moving Image Performed by Terminal Device 20 and Other Devices

Referring to FIG. 5, a specific example of operations for generating and transmitting a moving image performed by the terminal device 20 (the server 30 or the studio unit 40) at ST402 and ST404 in FIG. 4 will be described. FIG. 5 is a flowchart illustrating a specific example of the operations for generating and transmitting a moving image of the operations illustrated in FIG. 4.

A case where the subject that generates a moving image is the terminal device 20 (that is, the first aspect) will be described hereinbelow for ease of explanation. However, the subject that generates the moving image may be the server 30 (the second aspect) or the studio unit 40 (the third aspect).

First at ST502, the sensor unit 100 of the terminal device 20 obtains data on the performer (for example, every freely settable unit time interval), as described in Section 3.1.1.

Next at ST504, the change-amount acquisition unit 110 of the terminal device 20 obtains the amounts of change of the plurality of specific parts related to the performer on the basis of the data obtained from the sensor unit 100 (for example, every freely settable unit time interval), as described in Section 3.1.2.

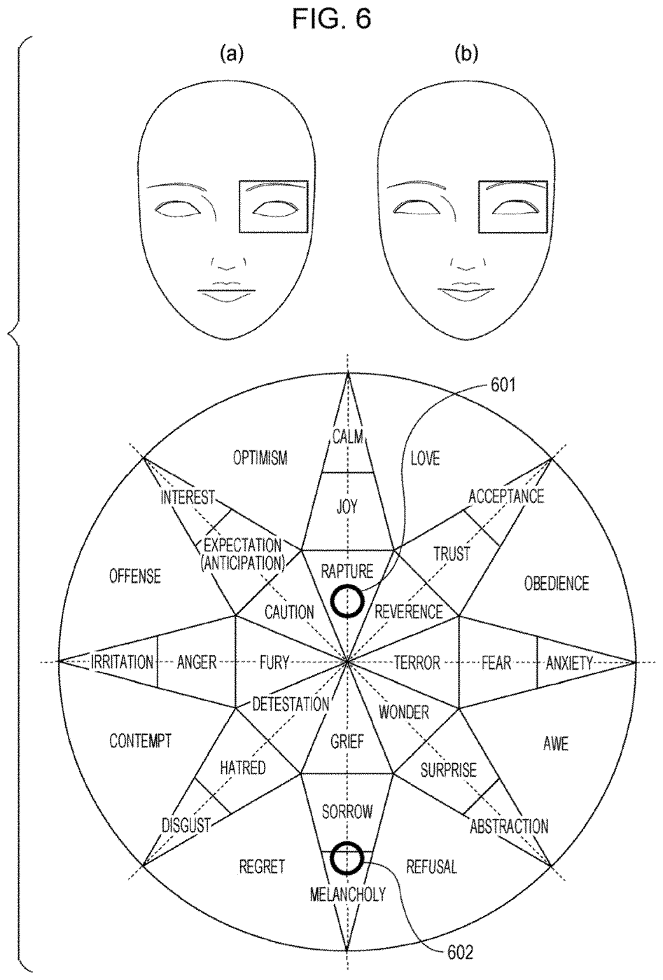

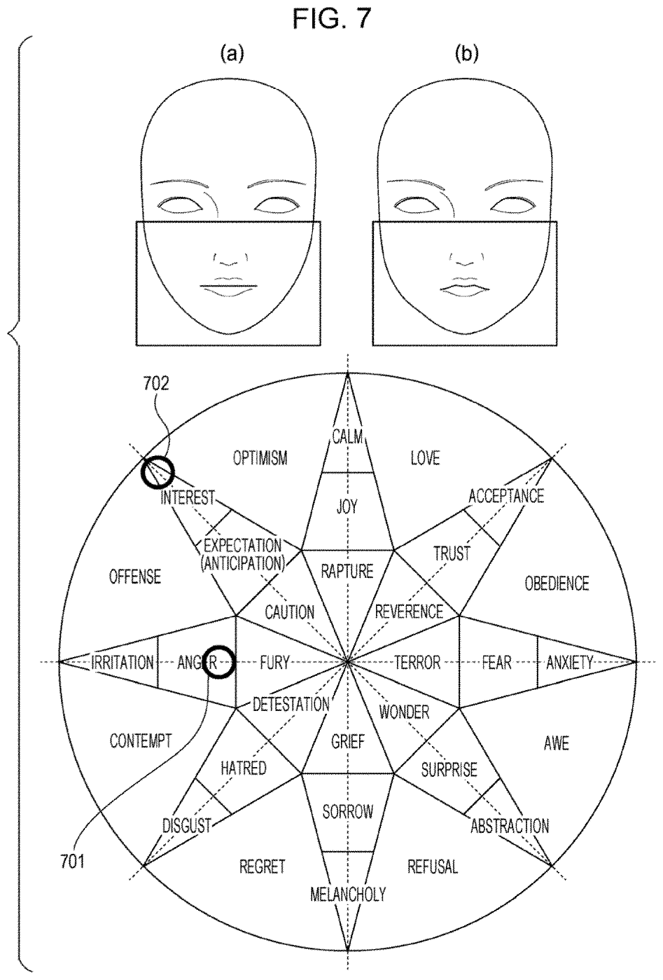

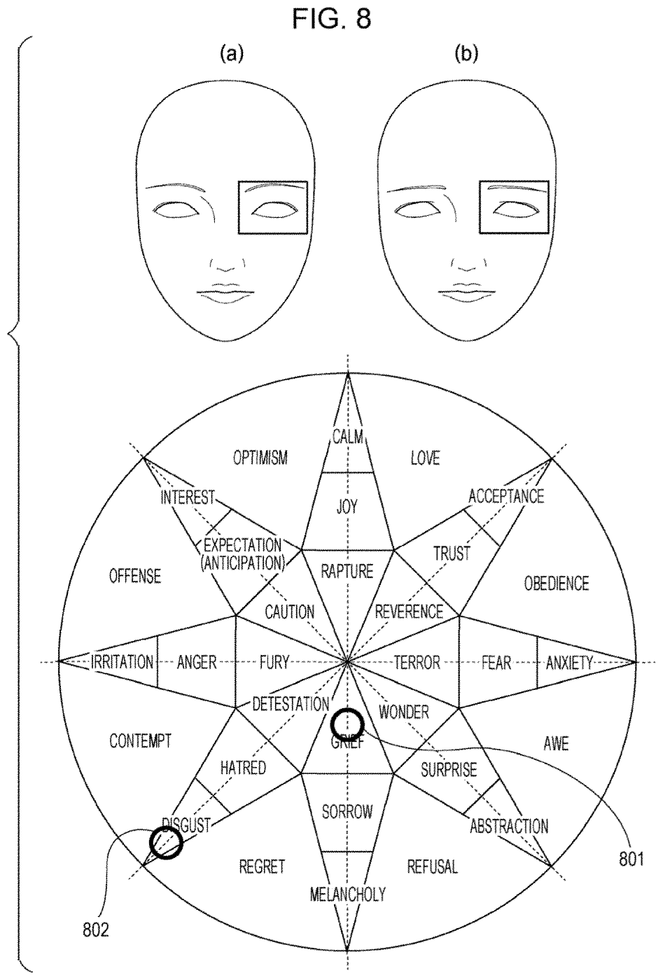

Next at ST506, the first-score acquisition unit 120 of the terminal device 20 obtains, for one or more specific feelings associated with the individual specific parts, first scores based on the amounts of change of the specific parts (for example, every freely settable unit time interval), as described in Section 3.1.3. Specific examples of the first scores will be described with reference to FIGS. 6 to 8. FIG. 6 is a schematic diagram conceptually illustrating a specific example of the first scores obtained by the communication system illustrated in FIG. 1. FIG. 7 is a schematic diagram conceptually illustrating another specific example of the first scores obtained by the communication system illustrated in FIG. 1. FIG. 8 is a schematic diagram conceptually illustrating yet another specific example of the first scores obtained by the communication system illustrated in FIG. 1.

As illustrated at the upper stage in FIG. 6, it is assumed that the shape of the corner of the right eye (or the corner of the left eye), which is a specific part of the performer, shift to lift significantly from (a) to (b) in a unit time interval. In this case, for the specific feeling of “joy” associated with this specific part, the first-score acquisition unit 120 obtains a first score based on the amount of change of the specific part. For the specific feeling of “sorrow” associated with this specific part, the first-score acquisition unit 120 obtains a first score based on the amount of change of the specific part. In an embodiment, for the specific feeling of “joy”, the first-score acquisition unit 120 can obtain a first score 601 having a greater value, as illustrated at the lower stage in FIG. 6. For the specific feeling of “sorrow”, the first-score acquisition unit 120 can obtain a first score 602 having a smaller value. The first score increases in value toward the center and decreases in value toward the outer edge at the lower stage in FIG. 6.

In another example, it is assumed that the shape of the right cheek (or the left cheek), which is a specific part of the performer, shifts to expand greatly from (a) to (b) in a unit time interval, as illustrated at the upper stage in FIG. 7. In this case, for the specific feeling of “anger” associated with this specific part, the first-score acquisition unit 120 obtains a first score based on the amount of change of the specific part. For the specific feeling of “expectation” associated with this specific part, the first-score acquisition unit 120 obtains a first score based on the amount of change of the specific part. In an embodiment, for the specific feeling of “anger”, the first-score acquisition unit 120 can obtain a first score 701 having a greater value, as illustrated at the lower stage in FIG. 7. For the specific feeling of “expectation”, the first-score acquisition unit 120 can obtain a first score 702 having a smaller value. The first score increases in value toward the center and decreases in value toward the outer edge also at the lower stage in FIG. 7.

In another example, it is assumed that the shape of the left external eyebrow (or the right external eyebrow), which is a specific part of the performer, shifts to droop greatly from (a) to (b) in a unit time interval, as illustrated at the upper stage in FIG. 8. In this case, for the specific feeling of “sorrow” associated with this specific part, the first-score acquisition unit 120 obtains a first score based on the amount of change of the specific part. For the specific feeling of “hatred” associated with this specific part, the first-score acquisition unit 120 obtains a first score based on the amount of change of the specific part. In an embodiment, for the specific feeling of “sorrow”, the first-score acquisition unit 120 can obtain a first score 801 having a greater value, as illustrated at the lower stage in FIG. 8. For the specific feeling of “hatred”, the first-score acquisition unit 120 can obtain a first score 802 having a smaller value. The first score increases in value toward the center and decreases in value toward the outer edge also at the lower stage in FIG. 8.

The feeling selection unit 140 can select a specific feeling having a second score exceeding a threshold (a second score given on the basis of the sum of the first scores) from among the plurality of specific feelings) as the feeling expressed by the performer. In other words, first scores given for one or more specific feelings associated with one specific part indicate the degree of contribution to the one or more specific feelings.

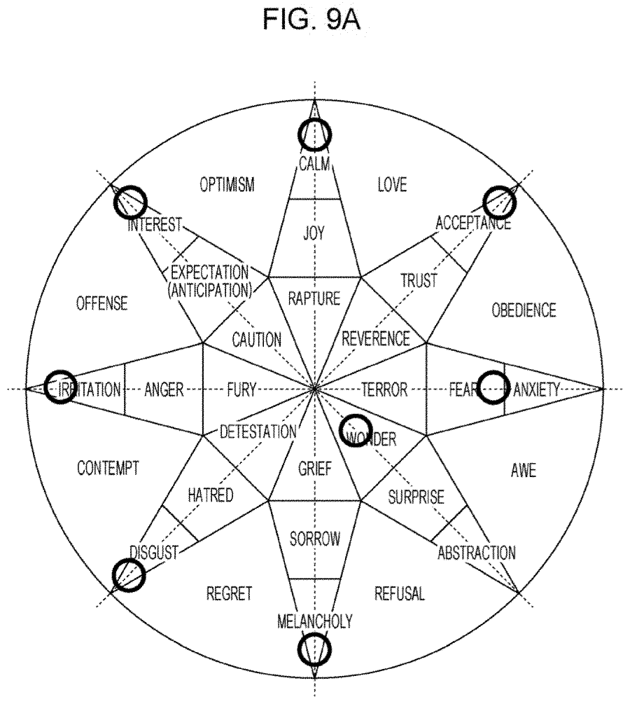

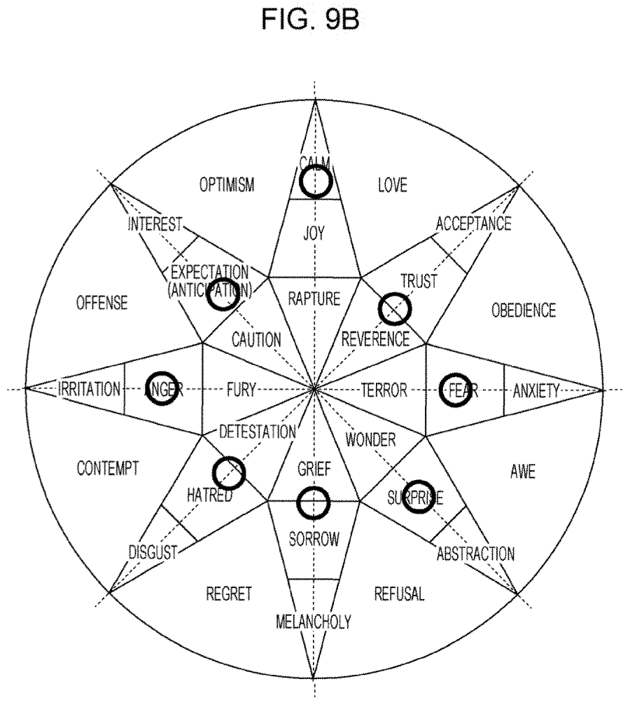

Referring back to FIG. 5, at ST508, the second-score acquisition unit 130 of the terminal device 20 obtains, for each of specific feelings, a second score based on the sum of the first scores given for the individual specific feelings (for example, every freely settable unit time interval) as described in Section 3.1.4. Referring also to FIGS. 9A and 9B, specific examples of the second score will be described. FIGS. 9A and 9B are schematic diagrams conceptually illustrating specific examples of the second score obtained by the communication system 1 illustrated in FIG. 1. The second score increases in value toward the center and decreases in value toward the outer edge also in FIGS. 9A and 9B.

FIG. 9A illustrates second scores obtained for the individual specific feelings by the second-score acquisition unit 130 at ST508. The second scores given for the individual specific feelings are obtained on the basis of the first scores obtained for the specific feelings by the first-score acquisition unit 120. In one embodiment, each of the second scores is the sum of the first scores obtained for the specific feeling by the first-score acquisition unit 120. In another embodiment, the second score is given by multiplying the sum of the first scores obtained by the first-score acquisition unit 120 for the specific feelings by a predetermined factor.

Referring back to FIG. 5, at ST510, the feeling selection unit 140 of the terminal device 20 selects a specific feeling having a second score exceeding a threshold from among a plurality of specific feelings (for example, every freely settable unit time interval) as the feeling expressed by the performer, as described in Section 3.1.5. For example, as illustrated in FIG. 9B, the threshold can be set or changed individually for each of the plurality of specific feelings (a second score corresponding thereto) at any timing by the performer who operates the terminal device 20 (and/or a performer and/or an operator who operates the server 30 and/or the studio unit 40).

The feeling selection unit 140 of the terminal device 20 can select a specific feeling having a second score exceeding a threshold as the feeling expressed by the performer by comparing second scores obtained for the individual specific feelings (for example, illustrated in FIG. 9A) with thresholds set for the specific feelings (for example, illustrated in FIG. 9B). In the example illustrated in FIGS. 9A and 9B, only the second score given for the specific feeling of “surprise” exceeds the threshold set for the specific feeling. This allows the feeling selection unit 140 to select the specific feeling of “surprise” as the feeling expressed by the performer. In one embodiment, the feeling selection unit 140 can also select not only the specific feeling of “surprise” but also a combination of the specific feeling of “surprise” and a second score as the feeling expressed by the performer. In other words, when the second score is relatively low, the feeling selection unit 140 can also select the relatively weak feeling of “surprise” as the feeling expressed by the performer. When the second score is relatively high, the feeling selection unit 140 can select a relatively strong feeling of “surprise” as the feeling expressed by the performer.

If there are multiple specific feelings having a second score exceeding the threshold, the feeling selection unit 140 can select one specific feeling having the highest second score of the multiple specific feelings as the feeling expressed by the performer.

If there are multiple specific feelings having the highest “same” second score, then, in a first example, the feeling selection unit 140 can select a specific feeling having the highest priority of the specific feelings having the “same” highest second score as the feeling expressed by the performer according to the priority determined for the individual specific feelings in advance by the performer and/or the operator. One specific example is a case in which individual performers each set for their avatars a character corresponding to or similar to their characters from among a plurality of prepared characters (for example, an “irritable” character). In this case, higher priority can be given to a specific feeling (for example, “anger”) corresponding to or similar to this set character (for example, an “irritable” character) of the plurality of specific feelings. The feeling selection unit 140 can select a specific feeling having the highest priority of the specific feelings having the same second score as the feeling expressed by the performer on the basis of the priority. In addition to and/or in place of that, the threshold for a specific feeling corresponding to or similar to the character set in this way (for example, an “irritable” character) may be changed to a value lower than thresholds for other specific feelings.

If there are multiple specific feelings having the highest “same” second score, then in a second example, the feeling selection unit 140 stores the frequency with which the specific feelings are selected in the past as their histories and can select a specific feeling with the highest frequency of a plurality of specific feelings having the highest “same” second score as the feeling expressed by the performer.

Referring back to FIG. 5, at ST512, the moving-image generation unit 150 of the terminal device 20 can generate a moving image in which a feeling selected by the feeling selection unit 140 is expressed in the virtual character (for example, every freely-settable unit time interval), as described in Section 3.1.6. The moving-image generation unit 150 can generate a moving image in which a feeling selected by the feeling selection unit 140 is expressed in the virtual character, in place of using only the feeling selected by the feeling selection unit 140 (simply, using only the feeling of “sorrow”), using the feeling and a second score corresponding to the feeling (great “sorrow” or small “sorrow”).

The moving-image generation unit 150 generates an image in which a facial expression corresponding to the specific feeling selected by the feeling selection unit 140 is expressed in the virtual character. This image may be a moving image in which the facial expression of the virtual character is kept for a predetermined time. The predetermined time may be set and changed at any timing by the user or the performer of the terminal device 20 (the user, the performer, or the operator of the server 30, or the user or the operator of the studio unit) via a user interface.

At ST512, the communication unit 180 of the terminal device 20 can transmit the moving image generated by the moving-image generation unit 150 to the server 30 via the communication network 10, as described in Section 3.1.7.

Next at ST514, the terminal device 20 determined whether to continue the process. If the terminal device 20 determines to continue the process, then the process returns to ST502, the processes from ST502 are repeated. If the terminal device 20 determines to end the process, the process ends.

In one embodiment, all of the processes ST502 to ST512 can be executed by the terminal device 20 (or the studio unit 40). In another embodiment, only ST502, only ST502 to ST504, only ST502 to 506, only ST502 to ST508, or only ST502 to ST510 may be executed by the terminal device 20 (or the studio unit 40), and the remaining processes may be executed by the server 30.

In other words, in another embodiment, at least one process from ST502 of ST502 to ST512 may be executed by the terminal device 20 (or the studio unit 40), and the remaining processes may be executed by the server 30. In this case, the terminal device 20 (or the studio unit 40) needs to transmit data obtained in the last process of ST502 to ST512 to the server 30. For example, if the processes to ST502 have been executed, the terminal device 20 (or the studio unit 40) needs to transmit “data on the performer” obtained at ST502 to the server 30. If the processes to ST504 have been executed, the terminal device 20 (or the studio unit 40) needs to transmit “the amount of change” obtained at ST504 to the server 30. Similarly, if the processes to ST506 (or ST508) have been executed, the terminal device 20 (or the studio unit 40) needs to transmit the “first score” (or the “second score”) obtained at ST506 (or ST508) to the server 30. If the processes to ST510 has been executed, the terminal device 20 (or the studio unit 40) needs to transmit the “feeling” obtained at ST510 to the server 30. If the terminal device 20 (or the studio unit 40) executes only any of the processes before ST512, then the server 30 generates an image based on the data received from the terminal device 20 (or the studio unit 40).

In yet another embodiment, only ST502, only ST502 to ST504, only ST502 to 506, only ST502 to ST508, or ST502 to ST510 may be executed by the terminal device 20 (or the studio unit 40), and the remaining processes may be executed by another terminal device (a viewer's terminal device) 20.

In other words, in still another embodiment, at least one process from ST502 of the processes from ST502 to ST512 may be executed in sequence by the terminal device 20 (or the studio unit 40), and the remaining processes may be executed by another terminal device (the viewer's terminal device) 20. In this case, the terminal device 20 (or the studio unit 40) needs to transmit data or the like obtained at the last process of ST502 to ST512 to another terminal device 20 via the server 30. For example, if the terminal device 20 (or the studio unit 40) has executed the processes to ST502, the terminal device 20 (or the studio unit 40) needs to transmit the “data on the performer” obtained at ST502 to another terminal device 20 via the server 30. If the terminal device 20 (or the studio unit 40) has executed the processes to ST504, the terminal device 20 (or the studio unit 40) needs to transmit “the amount of change” obtained at ST504 to another terminal device 20 via the server 30. Likewise, if the terminal device 20 (or the studio unit 40) has executed the process to ST506 (or ST508), the terminal device 20 (or the studio unit 40) needs to transmit the “first score” (or the “second score”) obtained at ST506 (or ST508) to another terminal device 20 via the server 30. If the terminal device 20 (or the studio unit 40) has executed the processes to ST510, the terminal device 20 (or the studio unit 40 needs to transmit the “feeling” obtained at ST510 to another terminal device 20 via the server 30. If the terminal device 20 (or the studio unit 40) executes only any of the processes before ST512, another terminal device 20 can generate and play back an image based on the data or the like received via the server 30.

6. Modifications

The thresholds that are individually set for a plurality of specific feelings (corresponding second scores) may be changed by the user, the performer, or the like of the terminal device 20, the user, the performer, the operator, or the like of the server 30, or the user, the operator, or the like of the studio unit 40 at any timing via user interfaces displayed on the displays of these devices or units.

The terminal device 20, the server 30, and/or the studio unit 40 can store thresholds individually for a plurality of specific feelings in the storage 170 (270) in association with individual characters. The terminal device 20, the server 30, and/or the studio unit 40 may read a threshold corresponding to a character selected via a user interface from the plurality of characters by the user, the performer, or the operator from the storage 170 (270) and may use the threshold. The plurality of characters include cheerful, gloomy, positive, negative, and any other characters. The terminal device 20 and/or the studio unit 40 can also receive thresholds that are determined for individual specific feelings associated with multiple characters from the server 30 and store the thresholds in the storage 170 (270). The terminal device 20 and/or the studio unit 40 can also transmit thresholds that are determined for the specific feelings associated with multiple characters and that are changed by the user, the performer, the operator, or the like thereof to the server 30. The server 30 can also transmit such thresholds to another terminal device 20 or the like for use.

In the above embodiments, the feeling selection unit 140 (240) selects a specific feeling having a second score exceeding a threshold as the feeling expressed by the performer from among multiple specific feelings. In combination, when a specific feeling is designated by the performer or the user at any timing via a user interface, the feeling selection unit 140 (240) may “preferentially” select the designated specific feeling as the feeling expressed by the performer. This allows the performer or the user to appropriately specify the intended specific feeling, for example, when an unintended specific feeling has been selected by mistake by the feeling selection unit 140 (240). Such specification of the specific feeling by the performer or the user can be applied to an aspect in which the terminal device 20 or the like generates a moving image in real time in parallel with the operation of obtaining data on the performer using the sensor unit 100. In addition to or in place of it, the specification of the specific feeling by the performer or the user can be applied to an aspect in which the terminal device 20 or the like reads an image that has been generated and stored in the storage 170 and displays the image on the display 160. In either aspect, the terminal device 20 or the like can instantly generate an image in which a facial expression corresponding to the feeling specified by the performer or the user is expressed in the virtual character in response to the specification and can display the image on the display 160.

Furthermore, the terminal device 20 or the like (for example, the feeling selection unit 140) can set a high threshold for the second score of a specific feeling having a first relationship (a conflicting or contradicting relationship) with the currently selected specific feeling. The first relationship is a conflicting or contradicting relationship. This allows the feeling selection unit 140, if the currently selected specific feeling (corresponding to the facial expression displayed on the display 160) is “sorrow”, to decrease the possibility of selecting a relationship conflicting “sorrow”, for example, “joy”. This eliminates or reduces the occurrence of a phenomenon in which the virtual character in the final image generated by the moving-image generation unit 150 instantly shifts awkwardly from, for example, the facial expression of “sorrow” to the facial expression of “joy”.

In contrast, the terminal device 20 (for example, the feeling selection unit 140) can set a low threshold for the second score of a specific feeling having a second relationship with the currently selected specific feeling. The second relationship is a similar or approximate relationship. This allows the feeling selection unit 140, if the currently selected specific feeling (corresponding to the facial expression displayed on the display 160) is “sorrow”, to increase the possibility of selecting, for example, “surprise” or “hatred” having a relationship similar to “sorrow”. This allows the occurrence of a phenomenon in which the virtual character in the final image generated by the moving-image generation unit 150 instantly shifts from, for example, the facial expression of “sorrow” to the facial expression of “surprise” or “hatred”.

In the various embodiments, the multiple specific parts related to the performer may include the performer's right eye, left eye, right cheek, left cheek, nose, right eyebrow, left eyebrow, chin, right ear, left ear, and any other specific parts. However, in another embodiment, the specific parts related to the performer may include the performer's voice, blood pressure, pulse, and body temperature. In this case, the sensor unit 100 (200) can use a microphone, a manometer, a pulse monitor, and a thermometer, respectively. The change-amount acquisition unit 110 (210) can obtain the amount of change in the frequency of the voice, the amount of change in the blood pressure, the amount of change in the pulse, or the amount of change in the body temperature, respectively, every unit time interval.

Thus, even if the facial expression of the performer is impossible to actually express, the above embodiments allow easily generating a moving image in which such a facial expression is expressed in the virtual character by setting the facial expression as a facial expression corresponding to at least one of multiple specific feelings. Examples of the impossible facial expression include a facial expression in which part of the upper body of the performer is replaced with a sign or the like and a facial expression in which part of the upper body of the performer pops out fantastically like an animation.

In some embodiments, facial expressions corresponding to individual specific feelings can be determined in advance. This allows selecting a specific feeling expressed by the performer on the basis of the first score and the second score from among multiple specific feelings and generating a moving image in which a facial expression corresponding to the selected specific feeling is expressed in a virtual character. This allows the performer, even if he/she does not recognize all the prepared facial expressions, to vary specific parts including the facial expression, voice, blood pressure, pulse, and body temperature while facing the terminal device 20 or the like. Thus, the terminal device 20 or the like can select an appropriate specific feeling from multiple specific feelings and generate a moving image in which a facial expression corresponding to the selected specific feeling is expressed in a virtual character.

Accordingly, the embodiments provide a computer program, a server, a terminal device, a system, and a method for causing a virtual character to give a facial expressions that the performer intends to express using a simple method.

7. Various Aspects

A computer program according to a first aspect causes a processor to obtain, an amount of change of each of a plurality of specific parts related to a performer, based on data on the performer obtained by a sensor, to obtain, for at least one specific feeling of a plurality of specific feelings associated with each of the specific parts, a first score based on the amount of change of the specific part, to obtain a second score based on a sum of the first scores obtained for the individual specific feelings for each of the plurality of specific feelings, and to select a specific feeling having a second score exceeding a threshold from among the plurality of specific feelings as a feeling expressed by the performer.

In a computer program according to a second aspect, in the first aspect, the threshold is individually set for each of the second scores of the plurality of specific feelings.

In a computer program according to a third aspect, in the first or second aspect, the threshold is changed at any timing by the performer or a user via a user interface.

In a computer program according to a fourth aspect, in any of the first to third aspects, the threshold is a threshold corresponding to a character selected, from thresholds prepared for individual plurality of characters, by the performer or a user via a user interface.

In a computer program according to a fifth aspect, in any of the first to fourth aspects, the processor generates an image in which a virtual character expresses a facial expression corresponding to the selected specific feeling for a predetermined time.

In a computer program according to a sixth aspect, in the fifth aspect, the predetermined time is changed by the performer or a user at any timing via a user interface.

In a computer program according to a seventh aspect, in any of the first to sixth aspects, a first score obtained, for a first specific feeling associated with one specific part, based on the amount of change of the specific part differs from a first score obtained, for a second specific feeling associated with the specific part, based on the amount of change of the specific part.

In a computer program according to an eighth aspect, in any of the first to seventh aspects, of the plurality of specific feelings, for a specific feeling having a first relationship with a currently selected specific feeling, the processor sets a high threshold for the second score of the specific feeling, and of the plurality of specific feelings, for a specific feeling having a second relationship with a currently selected specific feeling, the processor sets a low threshold for the second score of the specific feeling.

In a computer program according to a ninth aspect, in the eighth aspect, the first relationship is a conflicting relationship, and the second relationship is a similar relationship.

In a computer program according to a tenth aspect, in any of the first to ninth aspects, the first score indicates contribution to at least one of the specific feelings associated with the specific parts.

In a computer program according to an 11th aspect, in any of the first to tenth aspects, the data is obtained by the sensor in a unit time interval.

In a computer program according to a 12th aspect, in the 11th aspect, the unit time interval is set by the performer or a user.

In a computer program according to a 13th aspect, in any of the first to 12th aspects, the plurality of specific parts is selected from a group including a right eye, a left eye, a right cheek, a left cheek, a nose, a right eyebrow, a left eyebrow, a chin, a right ear, a left ear, and voice.

In a computer program according to a 14th aspect, in any of the first to 13th aspects, the plurality of specific feelings is selected by the performer via a user interface.

In a computer program according to a 15th aspect, in any of the first to 14th aspects, the processor selects a specific feeling having a highest second score as the feeling expressed by the performer from among a plurality of specific feelings having a second score exceeding the threshold.

In a computer program according to a 16th aspect, in any of the first to 15th aspects, the processor obtains priorities stored in association with the individual plurality of specific feelings, and wherein the processor selects a specific feeling having a highest priority as the feeling expressed by the performer from among a plurality of specific feelings having a second score exceeding the threshold.

In a computer program according to a 17th aspect, in any of the first to 15th aspects, the processor obtains a frequency stored in association with each of the plurality of specific feelings, the frequency being a frequency with which each specific feeling is expressed as the feeling expressed by the performer, and the processor selects a specific feeling having a highest frequency as the feeling expressed by the performer from among a plurality of specific feelings having a second score exceeding the threshold.

In a computer program according to an 18th aspect, in any of the first to 17th aspects, the processor includes a central processing unit (CPU), a microprocessor, and a graphic processing unit (GPU).

In a computer program according to a 19th aspect, in any of the first to 18th aspects, the processor is installed in a smartphone, a tablet, a mobile phone, a personal computer, or a server.

A terminal device according to a 20th aspect includes a processor, wherein the processor executes computer-readable instructions to obtain, an amount of change of each of a plurality of specific parts related to a performer, based on data on the performer obtained by a sensor, obtain, for at least one specific feeling of a plurality of specific feelings associated with each of the specific parts, a first score based on the amount of change of the specific part, obtain a second score based on a sum of the first scores obtained for the individual specific feelings for each of the plurality of specific feelings, and select a specific feeling having a second score exceeding a threshold from among the plurality of specific feelings as a feeling expressed by the performer.

In a terminal device according to a 21st aspect, in the 20th aspect, the processor is a central processing unit (CPU), a microprocessor, or a graphic processing unit (GPU).

In a terminal device according to a 22nd aspect, in the 20th or 21st aspect, the plurality of specific parts is selected from a group including a right eye, a left eye, a right cheek, a left cheek, a nose, a right eyebrow, a left eyebrow, a chin, a right ear, a left ear, and voice.

A terminal device according to a 23rd aspect is disposed in a studio in any of the 20th to 22nd aspects.

A server according to a 24th aspect includes a processor, wherein the processor executes computer-readable instructions to obtain, an amount of change of each of a plurality of specific parts related to a performer, based on data on the performer obtained by a sensor, obtain, for at least one specific feeling of a plurality of specific feelings associated with each of the specific parts, a first score based on the amount of change of the specific part, obtain a second score based on a sum of the first scores obtained for the individual specific feelings for each of the plurality of specific feelings, and select a specific feeling having a second score exceeding a threshold from among the plurality of specific feelings as a feeling expressed by the performer.

In a server according to a 25th aspect, in the 24th aspect, the processor is a central processing unit (CPU), a microprocessor, or a graphic processing unit (GPU).

In a server according to a 26th aspect, in the 24th or 25th aspect, the plurality of specific parts is selected from a group including a right eye, a left eye, a right cheek, a left cheek, a nose, a right eyebrow, a left eyebrow, a chin, a right ear, a left ear, and voice.

A server according to a 27th aspect is disposed in a studio in any of the 24 to 26th aspects.

A method according to a 28th aspect is a method executed by a processor that executes computer-readable instructions, the method including a change-amount acquisition step of obtaining, an amount of change of each of a plurality of specific parts related to a performer, based on data on the performer obtained by a sensor, a first-score acquisition step of obtaining, for at least one specific feeling of a plurality of specific feelings associated with each of the specific parts, a first score based on the amount of change of the specific part, a second-score acquisition step of obtaining a second score based on a sum of the first scores obtained for the individual specific feelings for each of the plurality of specific feelings, and a selection step of selecting a specific feeling having a second score exceeding a threshold from among the plurality of specific feelings as a feeling expressed by the performer.

In a method according to a 29th aspect, in the 28th aspect, the individual steps are executed by a processor installed in a terminal device selected from a group including a smartphone, a tablet, a mobile phone, and a personal computer.

In a method according to a 30th aspect, in the 28th aspect, of the change-amount acquisition step, the first-score acquisition step, the second-score acquisition step, and the selection step, only the change-amount acquisition step, only the change-amount acquisition step and the first-score acquisition step, or only the change-amount acquisition step, the first-score acquisition step, and the second-score acquisition step are executed by a processor installed in a terminal device selected from a group including a smartphone, a tablet, a mobile phone, and a personal computer, and remaining steps are executed by a processor installed in a server.

A method according to a 31st aspect, in any of the 28th to 30th aspects, the processor is a central processing unit (CPU), a microprocessor, or a graphic processing unit (GPU).

A method according to a 32nd aspect, in any of the 28th to 31st aspects, the plurality of specific parts is selected from a group including a right eye, a left eye, a right cheek, a left cheek, a nose, a right eyebrow, a left eyebrow, a chin, a right ear, a left ear, and voice.

A system according to a 33th aspect includes a first device including a first processor and a second device including a second processor and configured to connect to the first device via a communication line, wherein the first processor included in the first device executes computer-readable instructions to execute at least one of a change-amount acquisition process of obtaining, an amount of change of each of a plurality of specific parts related to a performer, based on data on the performer obtained by a sensor, a first-score acquisition process of obtaining, for at least one specific feeling of a plurality of specific feelings associated with each of the specific parts, a first score based on the amount of change of the specific part, a second-score acquisition process of obtaining a second score based on a sum of the first scores obtained for the individual specific feelings for each of the plurality of specific feelings, a selection process of selecting a specific feeling having a second score exceeding a threshold from among the plurality of specific feelings as a feeling expressed by the performer, and an image generation process of generating an image based on the selected feeling, in sequence from the change-amount acquisition process, wherein, when a remaining process that is not executed by the first processor is present, the second processor included in the second device executes the remaining process by executing computer-readable instructions.

In a system according to a 34th aspect, in the 33rd aspect, the second processor receives the image generated by the first processor via a communication line.

A system according to a 35th aspect further includes, in the 33th or 34th aspect, a third device including a third processor and configured to connect to the second device via a communication line, wherein the second processor transmits the generated image to the third device via a communication line, and wherein the third processor included in the third device executes computer-readable instructions to receive the image transmitted by the second processor via the communication line and to display the received image on a display.

In a system according to a 36th aspect, in in any of the 33rd to 35th aspects, the first device and the third device are each selected from a group including a smartphone, a tablet, a mobile phone, a personal computer, and a server, and the second device is a server.

A system according to a 37th aspect, in the 33th aspect, further includes a third device including a third processor and configured to connect to the first device and the second device via a communication line, wherein the first device and the second device are each selected from a group including a smartphone, a tablet, a mobile phone, a personal computer, and a server, wherein the third device is a server, wherein, when the first device executes only the change-amount acquisition process, the third device transmits the amount of change obtained by the first device to the second device, wherein, when the first device executes the change-amount acquisition process to the first-score acquisition process, the third device transmits the first score obtained by the first device to the second device, wherein, when the first device executes the change-amount acquisition process to the second-score acquisition process, the third device transmits the second score obtained by the first device to the second device, wherein, when the first device executes the change-amount acquisition process to the selection process, the third device transmits the feeling expressed by the performer obtained by the first device to the second device, and wherein, when the first device executes the change-amount acquisition process to the image generation process, the third device transmits the image generated by the first device to the second device.

In a system according to a 38th aspect, in any of the 33rd to 37th aspects, the communication line includes the Internet.

In a system according to a 39th aspect, in any of the 33rd to 38th aspects, the image includes a moving image and/or a still image.

A method according to a 40th aspect is a method executed by a system including a first device including a first processor and a second device including a second processor and configured to connect to the first device via a communication line, the method including a change-amount acquisition step of obtaining, an amount of change of each of a plurality of specific parts related to a performer, based on data on the performer obtained by a sensor, a first-score acquisition step of obtaining, for at least one specific feeling of a plurality of specific feelings associated with each of the specific parts, a first score based on the amount of change of the specific part, a second-score acquisition step of obtaining a second score based on a sum of the first scores obtained for the individual specific feelings for each of the plurality of specific feelings, a selection step of selecting a specific feeling having a second score exceeding a threshold from among the plurality of specific feelings as a feeling expressed by the performer, and an image generation step of generating an image based on the selected feeling, in sequence from the change-amount acquisition process, wherein the first processor included in the first device executes computer-readable instructions to execute at least one step from the first-score acquisition step, and wherein, when a remaining step that is not executed by the first processor is present, the second processor included in the second device executes the remaining step by executing computer-readable instructions.

In a method according to a 41st aspect, in the 40th aspect, the second processor receives the image generated by the first processor via a communication line.

In a method according to a 42th aspect, in the 40th or 41th aspects, the system further includes a third device including a third processor and configured to connect to the second device via a communication line, wherein the second processor transmits the generated image to the third device via a communication line, and wherein the third processor included in the third device executes computer-readable instructions to receive the image transmitted by the second processor via the communication line and to display the received image on a display.

In a method according to a 43rd aspect, in any of the 40th to 42nd aspects, the first device and the third device are each selected from a group including a smartphone, a tablet, a mobile phone, a personal computer, and a server, and the second device is a server.

In a method according to a 44th aspect, in the 40th aspect, the system further includes a third device including a third processor and configured to connect to the first device and the second device via a communication line, wherein the first device and the second device are each selected from a group including a smartphone, a tablet, a mobile phone, a personal computer, and a server, wherein the third device is a server, wherein, when the first device executes only the change-amount acquisition step, the third device transmits the amount of change obtained by the first device to the second device, wherein, when the first device executes the change-amount acquisition step to the first-score acquisition step, the third device transmits the first score obtained by the first device to the second device, wherein, when the first device executes the change-amount acquisition step to the second-score acquisition step, the third device transmits the second score obtained by the first device to the second device, wherein, when the first device executes the change-amount acquisition step to the selection step, the third device transmits the feeling expressed by the performer obtained by the first device to the second device, and wherein, when the first device executes the change-amount acquisition step to the image generation step, the third device transmits the image generated by the first device to the second device.

In a method according to a 45th aspect, in any of the 40th to 44th aspects, the communication line includes the Internet.

In a method according to a 46th aspect, in any of the 40th to 45th aspects, the image includes a moving image and/or a still image.

8. Fields to Which the Technique disclosed in the Application Can Be Applied

The technique disclosed in this application can be applied to the following fields, for example.
1. Application service for delivering live moving images in which virtual characters appear
2. Application service capable of communication using characters and avatars (virtual characters) (for example, a chat application, a messenger, and a mail application)
3. Game service for operating virtual characters whose facial expressions can be varied (for example, a shooting game, a love games, and a role-playing game)

FIG. 10 is a block diagram of processing circuitry that performs computer-based operations in accordance with the present disclosure. FIG. 10 illustrates processing circuitry 1000 of terminal device 20 and/or server 30.

Processing circuitry 1000 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

In an exemplary implementation, one or all of central processing unit 21, main storage 22, input/output interface 23, input unit 24, auxiliary storage 25, and output unit 26 of terminal device 20 may include, or be encompassed by, processing circuitry 1000. In other implementations, central processing unit 31, main storage 32, input/output interface 33, input unit 34, auxiliary storage 35, and output unit 36 of server 30 may include, or be encompassed by, processing circuitry 1000.

In FIG. 10, the processing circuitry 1000 includes a CPU 1001 which performs one or more of the control processes discussed in this disclosure. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry 1000 communicates, such as a server or computer. The processes may also be stored in network based storage, cloud-based storage or other mobile accessible storage and executable by processing circuitry 1000.

Further, the claimed advancements may be provided as a utility application, background daemon, or component of an operating system, or combination thereof, executing in conjunction with CPU 1001 and an operating system such as Microsoft Windows, UNIX, Solaris, LINUX, Apple MAC-OS, Apple iOS and other systems known to those skilled in the art.

The hardware elements in order to achieve the processing circuitry 1000 may be realized by various circuitry elements. Further, each of the functions of the above described embodiments may be implemented by circuitry, which includes one or more processing circuits. A processing circuit includes a particularly programmed processor, for example, processor (CPU) 1001, as shown in FIG. 10. A processing circuit also includes devices such as an application specific integrated circuit (ASIC) and conventional circuit components arranged to perform the recited functions.

In FIG. 10, the processing circuitry 1000 may be a computer or a particular, special-purpose machine. Processing circuitry 1000 is programmed to execute control processing.

Alternatively, or additionally, the CPU 1001 may be implemented on an FPGA, ASIC, PLD or using discrete logic circuits, as one of ordinary skill in the art would recognize. Further, CPU 1001 may be implemented as multiple processors cooperatively working in parallel to perform the instructions of the inventive processes described above.

The processing circuitry 1000 in FIG. 10 also includes a network controller 1006, such as an Ethernet PRO network interface card, for interfacing with network 1100. As can be appreciated, the network 1100 can be a public network, such as the Internet, or a private network such as a local area network (LAN) or wide area network (WAN), or any combination thereof and can also include Public Switched Telephone Network (PSTN) or Integrated Services Digital Network (ISDN) sub-networks. The network 1100 can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, network controller 1006 may be compliant with other direct communication standards, such as Bluetooth, a near field communication (NFC), infrared ray or other.

The processing circuitry 1000 further includes a display controller 108, such as a graphics card or graphics adaptor for interfacing with display 1009, such as a monitor. An I/O interface 1012 interfaces with a keyboard and/or mouse 1014 as well as a touch screen panel 1016 on or separate from display 1009. I/O interface 1012 also connects to a variety of peripherals 1018.

The storage controller 1024 connects the storage medium disk 1004 with communication bus 1026, which may be an ISA, EISA, VESA, PCI, or similar, for interconnecting all of the components of the processing circuitry 1000. A description of the general features and functionality of the display 1009, keyboard and/or mouse 1014, as well as the display controller 1008, storage controller 1024, network controller 1006, and I/O interface 1012 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

What is claimed is:

1. A non-transitory computer readable medium storing computer executable instructions which, when executed by a processor, cause the processor to:
obtain, based on data of a performer obtained by a sensor, an amount of change of each of a plurality of specific parts of a face of the performer;
obtain, for at least one specific feeling of a plurality of specific feelings associated with each of the specific parts, a first score based on the amount of change of the specific part;
obtain a second score, based on a sum of the first scores obtained for the at least one specific feeling, for each specific feeling of the plurality of specific feelings; and
select a specific feeling, having a second score exceeding a threshold from among the plurality of specific feelings, as a feeling expressed by the performer.

2. The non-transitory computer readable medium according to claim 1, wherein the threshold is individually set for each second score corresponding to the plurality of specific feelings.

3. The non-transitory computer readable medium according to claim 1, wherein the threshold is changed at any timing by the performer or by a user via a user interface.

4. The non-transitory computer readable medium according to claim 1, wherein the threshold corresponds to a character selected, from thresholds prepared for individual characters of a plurality of characters, by the performer or by a user via a user interface.

5. The non-transitory computer readable medium according to claim 1, wherein the processor is further caused to generate an image in which a virtual character expresses a facial expression corresponding to the selected specific feeling for a predetermined time.

6. The non-transitory computer readable medium according to claim 5, wherein the predetermined time is changed by the performer or by a user at any timing via a user interface.

7. The non-transitory computer readable medium according to claim 1, wherein one first score obtained, for a first specific feeling associated with one specific part, based on the amount of change of the specific part differs from another first score obtained, for a second specific feeling associated with the specific part, based on the amount of change of the specific part.

8. The non-transitory computer readable medium according to claim 1, wherein the processor is further caused to:
set, for a specific feeling of the plurality of specific feelings and having a first relationship with a currently selected specific feeling, a high threshold for the second score of the specific feeling, and
set, for a specific feeling of the plurality of specific feelings and having a second relationship with a currently selected specific feeling, a low threshold for the second score of the specific feeling.

9. The non-transitory computer readable medium according to claim 8, wherein
the first relationship is a conflicting relationship, and
the second relationship is a similar relationship.

10. The non-transitory computer readable medium according to claim 1, wherein the first score indicates contribution to at least one of the specific feelings associated with the specific parts.

11. The non-transitory computer readable medium according to claim 1, wherein the data is obtained by the sensor in a unit time interval.

12. The non-transitory computer readable medium according to claim 11, wherein the unit time interval is set by the performer or a user.

13. The non-transitory computer readable medium according to claim 1, wherein the plurality of specific parts is selected from a group including a right eye, a left eye, a right cheek, a left cheek, a nose, a right eyebrow, a left eyebrow, a chin, a right ear, a left ear, and voice.

14. The non-transitory computer readable medium according to claim 1, wherein the plurality of specific feelings is selected by the performer via a user interface.

15. The non-transitory computer readable medium according to claim 1, wherein the processor selects the specific feeling which has a highest second score from among a plurality of specific feelings having a second score exceeding the threshold.

16. The non-transitory computer readable medium according to claim 1, wherein
the processor is further caused to obtain priorities stored in association with the individual specific feeling of the plurality of specific feelings, and
the processor selects the specific feeling which has a highest priority from among a plurality of specific feelings having a second score exceeding the threshold.

17. The non-transitory computer readable medium according to claim 1, wherein
the processor is further caused to obtain a frequency stored in association with each specific feeling of the plurality of specific feelings, the frequency being a frequency with which each specific feeling is selected as the feeling expressed by the performer, and
the processor selects the specific feeling which has a highest frequency from among a plurality of specific feelings having a second score exceeding the threshold.

18. A device, comprising:
a processor configured to:
obtain, based on data of a performer obtained by a sensor, an amount of change of each of a plurality of specific parts of a face of the performer;
obtain, for at least one specific feeling of a plurality of specific feelings associated with each of the specific parts, a first score based on the amount of change of the specific part;
obtain a second score, based on a sum of the first scores obtained for the at least one specific feeling, for each specific feeling of the plurality of specific feelings; and
select a specific feeling, having a second score exceeding a threshold from among the plurality of specific feelings, as a feeling expressed by the performer.

19. The device according to claim 18, wherein the plurality of specific parts is selected from a group including a right eye, a left eye, a right cheek, a left cheek, a nose, a right eyebrow, a left eyebrow, a chin, a right ear, a left ear, and voice.

20. A method, comprising:
a change-amount acquisition step of obtaining, based on data of a performer obtained by a sensor, an amount of change of each of a plurality of specific parts of a face of the performer;
a first-score acquisition step of obtaining, for at least one specific feeling of a plurality of specific feelings associated with each of the specific parts, a first score based on the amount of change of the specific part;
a second-score acquisition step of obtaining a second score, based on a sum of the first scores obtained for the at least one specific feeling, for each specific feeling of the plurality of specific feelings; and
a selection step of selecting a specific feeling, having a second score exceeding a threshold from among the plurality of specific feelings, as a feeling expressed by the performer.

21. The method according to claim 20, wherein the individual steps are executed by a processor installed in a terminal device selected from a group including a smartphone, a tablet, a mobile phone, and a personal computer.

22. The method according to claim 20, wherein
only the change-amount acquisition step, only the change-amount acquisition step and the first-score acquisition step, or only the change-amount acquisition step, the first-score acquisition step and the second-score acquisition step are executed by a processor installed in a terminal device, and
remaining steps of the change-amount acquisition step, the first-score acquisition step, the second-score acquisition step and the selection step are executed by a processor installed in a server.

23. The method according to claim 20, wherein the plurality of specific parts is selected from a group including a right eye, a left eye, a right cheek, a left cheek, a nose, a right eyebrow, a left eyebrow, a chin, a right ear, a left ear, and voice.

24. A system, comprising:
a first device including a first processor; and
a second device including a second processor and configured to connect to the first device via a communication line, wherein
the first processor is configured to execute at least one of:
a change-amount acquisition process of obtaining, based on data of a performer obtained by a sensor, an amount of change of each of a plurality of specific parts of a face of the performer;
a first-score acquisition process of obtaining, for at least one specific feeling of a plurality of specific feelings associated with each of the specific parts, a first score based on the amount of change of the specific part;
a second-score acquisition process of obtaining a second score, based on a sum of the first scores obtained for the at least one specific feeling, for each specific feeling of the plurality of specific feelings;
a selection process of selecting a specific feeling, having a second score exceeding a threshold from among the plurality of specific feelings, as a feeling expressed by the performer; and
an image generation process of generating an image based on the selected feeling, in sequence from the change-amount acquisition process, and
the second processor is configured to execute any of the change-amount acquisition process, the first-score acquisition process, the second-score acquisition process, the selection process and the image generation process which are not executed by the first processor.

25. The system according to claim 24, wherein in a case that the first processor executes the image generation process, the second processor receives the image generated by the first processor via a communication line.

26. The system according to claim 24, further comprising:
a third device including a third processor and configured to connect to the second device via a communication line, wherein
the second processor transmits the generated image to the third device via a communication line, and
the third processor is configured to receive the image transmitted by the second processor via the communication line and to display the image on a display.

27. The system according to claim 26, wherein
in a case that the first device executes only the change-amount acquisition process, the third device transmits the amount of change obtained by the first device to the second device,
in a case that the first device executes only the change-amount acquisition process and the first-score acquisition process, the third device transmits the first score obtained by the first device to the second device,
in a case that the first device executes only the change-amount acquisition process, the first-score acquisition process and the second-score acquisition process, the third device transmits the second score obtained by the first device to the second device,
in a case that the first device executes only the change-amount acquisition process, the first-score acquisition process, the second-score acquisition process and the selection process, the third device transmits the feeling expressed by the performer obtained by the first device to the second device, and
in a case that the first device executes the change-amount acquisition process, the first-score acquisition process, the second-score acquisition process, the selection process and the image generation process, the third device transmits the image generated by the first device to the second device.

28. The system according to claim 27, wherein the image includes a moving image and/or a still image.
